(19) United States
(12) Patent Application Publication
(10) Pub. No.: US 2022/0072872 A1
(43) Pub. Date: Mar. 10, 2022

(54) PRINTER CONFIGURATION FOR LATE STAGE MARKING ON CORRUGATED STOCK

(71) Applicant: Xerox Corporation, Norwark, CT (US)

(72) Inventors: Seemit Praharaj, Webster, NY (US); Anthony S. Condello, Webster, NY (US); Paul McConville, Webster, NY (US)

(21) Appl. No.: 17/015,289

(22) Filed: Sep. 9, 2020

(51) Int. Cl. B41J 3/01; G06K 1/12; G06K 15/10

(52) U.S. Cl. CPC B41J 3/01; G06K 15/102; G06K 1/121

(57) ABSTRACT

A printing system, including an atomizer operatively arranged to deliver a first ink and a printhead arranged adjacent to the atomizer, the printhead operatively arranged to deliver a second ink, the second ink being different from the first ink, wherein a print media including a dark color is operatively arranged to pass under, in order, the atomizer and the printhead.

### FIELD

The present disclosure relates to the field of printing, and more particularly, to the field of printing machine-readable labels such as barcodes, and even more particularly, to a printing system that can print a machine-readable label directly on corrugated stock.

### BACKGROUND

Packaging is the science, art, and technology of enclosing or protecting products for distribution, storage, sale, and use. Packaging also refers to the process of designing, evaluating, and producing packages. Packaging can be described as a coordinated system of preparing goods for transport, warehousing, logistics, sale, and end use. Packaging contains, protects, preserves, transports, informs, and sells. In many countries it is fully integrated into government, business, institutional, industrial, and personal use. Package labeling (American English) or labelling (British English) is any written, electronic, or graphic communication on the package or on a separate but associated label. Packages and labels communicate how to use, transport, recycle, or dispose of the package or product. With pharmaceuticals, food, medical, and chemical products, some types of information are required by government legislation. Some packages and labels also are used for track and trace purposes. Most items include their serial and lot numbers on the packaging, and in the case of food products, medicine, and some chemicals the packaging often contains an expiry/best-before date, usually in a shorthand form. Packages may indicate their construction material with a symbol.

Corrugated fiberboard is a material consisting of a fluted corrugated sheet and one or two flat linerboards. It is made on “flute lamination machines” or “corrugators” and is used for making cardboard boxes. The corrugated medium sheet and the linerboards are made of kraft containerboard, a paperboard material usually over 0.25 mm thick. Corrugated fiberboard is sometimes called corrugated cardboard or corrugated stock, although cardboard might be any heavy paper-pulp based board.

Often times information is communicated by a packaging label via a barcode or Quick Response (QR) code. A key challenge for packaging printers is the ability to print package specific information directly onto the package itself. Shipping labels/barcodes on packages being shipped, for example, from AMAZON® shipping services, represents a typical scenario where the ability to print information directly onto the package would greatly simplify the fulfillment process. The current system employed in such fulfillment centers is to print the barcode onto a sticker (i.e., a piece of printed paper with pressure sensitive adhesive on one side) and then peeling off the sticker and pressing it onto a box or package. This process is slow and prone to errors. Additionally, current print systems cannot print barcodes directly on corrugated stock (i.e., the box) with a sufficient degree of detail such that a barcode scanner can read such barcodes. This is largely due to the color (i.e., typically a shade of brown) and porosity of the corrugated stock.

Therefore, there is a long felt need for a system and method for printing the shipping label, barcode, and/or QR code directly on the box or package to eliminate the current sticker process. There is also a long felt need for a system and method for printing the shipping label, barcode, and/or QR code directly on corrugated stock such that a barcode or QR scanner can properly read the information depicted thereby.

### SUMMARY

According to aspects illustrated herein, there is provided a printing system, comprising an atomizer operatively arranged to deliver a first ink, and a printhead arranged adjacent to the atomizer, the printhead operatively arranged to deliver a second ink, the second ink being different from the first ink, wherein a print media including a dark color is operatively arranged to pass under, in order, the atomizer and the printhead.

In some embodiments, the print media comprises corrugated stock, and the atomizer applies the first ink to the corrugated stock to form a first layer. In some embodiments, the printhead applies the second ink to the first layer to form a second layer. In some embodiments, the second layer comprises a machine-readable code. In some embodiments, the first ink is a liquid light-colored ink. In some embodiments, the second ink is a liquid dark-colored ink. In some embodiments, the printing system further comprises a dryer arranged adjacent to the printhead, wherein the print media is operatively arranged to pass under, in order, the atomizer, the printhead, and the dryer. In some embodiments, the printing system further comprises a first dryer arranged between the atomizer and the printhead, and a second dryer arranged adjacent to the printhead, wherein the corrugated stock is operatively arranged to pass under, in order, the atomizer, the first dryer, the printhead, and the second dryer. In some embodiments, the first dryer is operatively arranged to dry the first layer and the second dryer is operatively arranged to dry the second layer. In some embodiments, the first layer comprises a brightness L* of greater than or equal to 65. In some embodiments, the first layer comprises a brightness L* of greater than or equal to 92. In some embodiments, the first ink comprises a first viscosity, the second ink comprises a second viscosity, and the second viscosity is greater than the first viscosity.

According to aspects illustrated herein, there is provided a printing system for printing a readable label directly on corrugated stock, comprising a low resolution atomizer operatively arranged to apply a white ink to the corrugated stock to form a first layer, a high resolution printhead operatively arranged adjacent to the low resolution atomizer to deliver a black ink to the first layer to form a code, and at least one dryer arranged adjacent to the high resolution printhead to dry at least one of the white ink and the black ink, wherein the corrugated stock is operatively arranged to pass under the low resolution atomizer, the high resolution printhead, and the at least one dryer.

In some embodiments, the at least one dryer comprises a first dryer arranged between the low resolution atomizer and the printhead to dry the white ink, and a second dryer arranged adjacent the high resolution printhead to dry the black ink. In some embodiments, the first layer is applied only to a portion of the corrugated stock. In some embodiments, the white ink comprises a water-based white liquid ink that is sprayed onto a predetermined area of the corrugated stock. In some embodiments, the white ink comprises a first viscosity, the black ink comprises a second viscosity, and the second viscosity is greater than the first viscosity. In some embodiments, the white ink comprises a first surface tension, the black ink comprises a second surface tension, and the second surface tension is substantially equal to the first surface tension.

According to aspects illustrated herein, there is provided a method for printing a readable label directly on corrugated stock having a surface, the method comprising applying, via one or more low resolution atomizers, a white ink to a portion of the surface to form a first layer, and applying, via one or more high resolution printheads, a black ink to the first layer to form a machine-readable code.

In some embodiments, the method further comprises, after the step of applying the white ink, drying, via one or more first dryers, the first layer, and after the step of applying the black ink, drying, via one or more second dryers, the machine-readable code.

In some embodiments, the present disclosure printing unit includes an atomized delivery of water-based white ink followed by a printhead dispensing a water-based black ink on top of the white ink. The use of black ink against a white background provides sufficient contrast for bar code readers as well as regular text perception.

In some embodiments, the present disclosure includes a low resolution atomized white ink delivery array in order to make a white background (step 1) essential to providing enhanced contrast between the created background and the ink to be put down as described in step 2. In some embodiments, the present disclosure includes a high resolution printhead, for example, a 1200 Dots Per Inch (dpi), such as a XEROX® WHlb printer, capable of printing small text and barcodes with a high level of detail (step 2). In some embodiments, the present disclosure includes a dryer capable of delivering sufficient energy to dry the ink put down on the corrugated stock as described in steps 1 and 2 (step 3).

According to aspects illustrated herein, there is provided a print system including a low resolution atomizer (white ink), a high resolution printhead (black ink), and one or more dryers. In some embodiments, the print system further comprises a conveyor belt or line. Finished corrugated boxes are displaced in a first direction via a conveyor belt, such that the boxes first pass under the low resolution atomizer and then pass under the high resolution printhead. In some embodiments, a dryer is positioned such that the boxes pass under the dryer after passing under the high resolution printhead. In some embodiments, a dryer is positioned such that the boxes pass under the dryer after passing under the low resolution atomizer but before passing under the high resolution printhead. In some embodiments, a first dryer is positioned between the low resolution atomizer and a second dryer is positioned after the high resolution printhead, such that the boxes pass under, in order, the low resolution atomizer, the first dryer, the high resolution printhead, and the second dryer.

In some embodiments, the low resolution atomizer uses a water-based white ink, for example, MTN® Water Based 100 Spray Paint—Titanium White (W1RV-9010), made by SPRAY PLANET® by MONTANA COLORS® paints, to construct the background or the first layer on the box. In some embodiments, the white ink is delivered via a low pressure atomizer directly onto the corrugated stock of the box in a pre-marked area. In some embodiments, the lightness, known as Commission Internationale de l'Eclairage—International Commission on Illumination (CIE) L* or L*, is greater than or equal to 65. A L* of 65 is considered to be the minimum for white for such applications (i.e., the printing of readable barcodes). In some embodiments, the L* of the first layer greater than or equal to 92.

In some embodiments, the high resolution printhead is run at 1200 dpi (8 pl physical drop volume) and uses a water-based black ink to construct the barcode or the second layer on the box.

According to aspects illustrated herein, there is provided a printer configuration with late stage marking capability on corrugated stock or cardboard. The printer configuration utilizes a combination of a low resolution atomizer with a high resolution printhead. A first layer white background is created with the low resolution atomizer, a high resolution printhead then prints the package specific information on the top of the first layer white background providing enhanced contrast for barcodes and text.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic view of a printing system;

FIG. 2 is a schematic view of a printing system;

FIG. 3A is a top elevational view of a box;

FIG. 3B is a side elevational view of the box shown in FIG. 3A;

FIG. 4A is a top elevational view of the box shown in FIG. 3A, with a first layer applied thereto;

FIG. 4B is a side elevational view of the box shown in FIG. 4A;

FIG. 5A is a top elevational view of a box shown in FIG. 4A, with a second layer applied thereto;

FIG. 5B is a side elevational view of the box shown in FIG. 5A; and,

FIG. 6 is a chart showing sample results.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

“Print system,” “printer,” “printer system,” “printing system,” “printer device,” “printing device,” and “multi-functional device (MFD)” as used herein encompass any apparatus, such as a digital copier, bookmaking machine, facsimile machine, multi-function machine, etc., which performs a print outputting function for any purpose. Furthermore, as used herein, “corrugated stock,” “cardboard,” “corrugated fiberboard,” “cardboard box,” “box,” “print media,” and “package” refer to, for example, substrates or media in which information or markings can be visualized and/or reproduced.

As used herein, “fusing,” with respect to dry marking material such as toner, is intended to mean supplying heat energy and/or pressure, having the effect of slightly liquifying the applied dry marking material (toner) particles, in turn causing them to adhere to a surface. “Drying,” as used herein, is intended to mean applying energy, typically but not necessarily heat in radiant and/or convective form, having the effect of causing a liquid component of the ink (a liquid marking material) to evaporate. “Curing,” as used herein, for example with respect to IR inks (liquid marking material) is intended to mean applying energy, such as by typically but not necessarily infrared waves, having the effect of causing a chemical reaction within at least one component of the applied ink, thereby fixing the ink to a surface.

“Process direction,” as used herein, is intended to mean the direction print media travels through the system, while “cross-process direction” is intended to mean the direction perpendicular to the process direction.

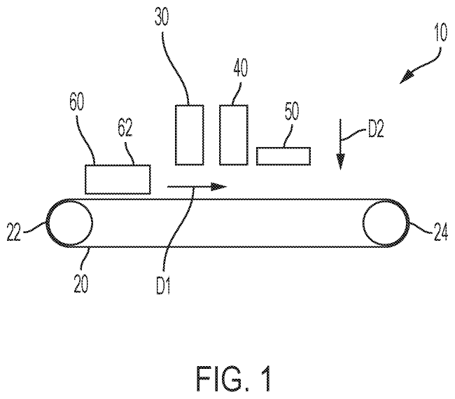

Referring now to the figures, FIG. 1 is a schematic view of printing system 10. Printing system 10 generally comprises conveyor belt or line 20, one or more atomizers (e.g., atomizer 30), and one or more printheads (e.g., printhead 40). In some embodiments, printing system 10 further comprises dryer 50.

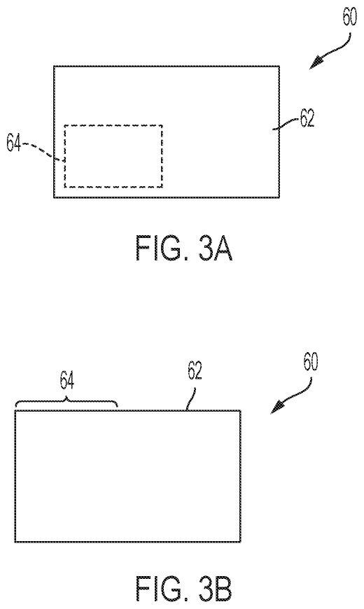

Conveyor belt 20 is operatively arranged to transport box or package or print media 60 in direction D1 (i.e., process direction) such that box 60 passes under atomizer 30, printhead 40, and dryer 50. The speed of conveyor belt 20 is adjustable, for example, by adjusting the rotational speed of rollers 22 and 24. As box 60 is displaced in direction D1, ink and/or heat is applied thereto in direction D2. As shown in FIGS. 3A-B, box 60 comprises surface 62 which is exposed to atomizer 30, printhead 40, and dryer 50. FIG. 3A is a top elevational view of box 60. FIG. 3B is a side elevational view of box 60. Surface 62 comprises a generally dark color, for example, brown, black, blue, green, orange, dark yellow, red purple, tan, grey, etc. Surface 62 may also comprise corrugated stock (i.e., a corrugated box or package). In some embodiments, surface 62 comprises a preselected area 64 in which various inks are to be applied. It should be appreciated that in some embodiments, conveyor belt 20 may displace box 60 in the cross-process direction in order to properly position area 64 under atomizer 30, printhead 40, and dryer 50. Alternatively, atomizer 30, printhead 40, and dryer 50 may be adjustable in the cross-process direction for proper positioning over area 64. It should be appreciated that while box 60 is intended to be finished (i.e., set up) prior to proceeding to atomizer 30, printhead 40, and dryer 50, layers 70 and 80 may be applied to box 60 in the unfinished (i.e., flat or knocked down) form. It should further be appreciated that preselected area 64 may differ depending on the size and shape of box 60. For example, on a smaller sized box 60, it may be desirable to print a very small machine-readable code (e.g., a barcode, QR code, etc.), in which case layer 70 and thus preselected area 64 can be greatly reduced. Whereas a larger box might not require such a small machine-readable code and thus layer 70 and preselected are 64 can be larger. Additionally, depending on the information to be applied via layer 80, the shape of preselected area 64 can be adjusted. For example, if a square QR code is to be printed via layer 80, then layer 70 and preselected area 64 can also be square shape. However, if a barcode is to be printed via layer 80, then it may be desired to apply layer 70 in a rectangular shape. The adjustability of preselected area 64, and layer 70, will help minimize costs associated with white or light-colored ink usage.

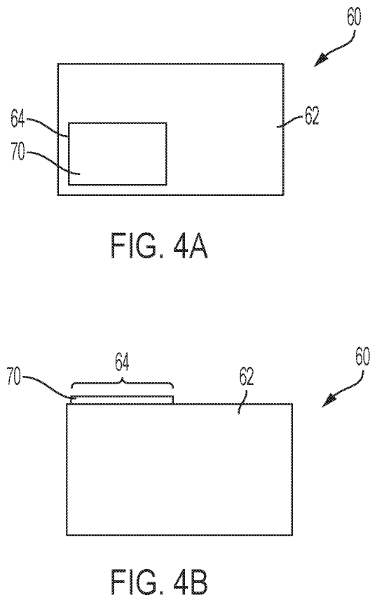

Atomizer 30 is operatively arranged over conveyor belt 20 to deliver a marking material (e.g., liquid ink) to box 60 generally in direction D2. As shown in FIGS. 4A-B, atomizer 30 delivers first layer 70 to box 60, specifically area 64 on surface 62. FIG. 4A is a top elevational view of box 60, with first layer 70 applied thereto. FIG. 4B is a side elevational view of box 60, with first layer 70 applied thereto. Layer 70 forms the background for the printed label, as will be described in greater detail below. In some embodiments, atomizer 30 is a low resolution atomizer that delivers low resolution atomized white ink to surface 62. In some embodiments, atomizer 30 applies a water-based white ink, for example, MTN® Water Based 100 Spray Paint—Titanium White (W1RV-9010), made by SPRAY PLANET® by MONTANA COLORS® paints, to surface 62. In some embodiments, atomizer 30 applies a solvent-based white ink to surface 62. In some embodiments, atomizer 30 is a low pressure atomizer. In some embodiments, atomizer 30 is a high pressure atomizer. It should be appreciated that while atomizer 30 is arranged to deliver a liquid marking material (i.e., ink), in some embodiments, a dry marking material (i.e., toner) may be used in conjunction with a fuser in order to apply first background layer 70 to box 60. As is known in the art, toner particles require fusion to the substrate after application. It should be appreciated that in some embodiments, printing system 10 may comprise one or more atomizers, for example, multiple atomizers arranged in series in the process direction. By arranging atomizers in series the desired L* may be more easily achieved.

By atomizing the liquid ink (i.e., producing a fine spray) to apply first layer 70 to surface 62, the desired droplet size of the ink can be obtained in an effort to conserve ink (i.e., to avoid unnecessary waste and save on costs). For example, it is desired that just enough liquid white ink be applied to surface 62 such that a first layer having a suitable lightness L* is created.

This can be accomplished by increasing or decreasing the droplet size of atomizer 30. In some embodiments, the L* of first layer 70 (see FIGS. 4A-B) is greater than or equal to 65. A L* of 65 is considered to be the minimum for the printing of readable barcodes. In some embodiments, the L* of first layer 70 greater than or equal to 92. It should be appreciated that layer 70 should comprise a light-colored ink, and instead of white, layer 70 may comprise another light color, for example, light blue, brown, beige, pink, yellow, green, orange, red, etc., or a color with a L* of greater than or equal to 65, and preferable, greater than or equal to 92. Additionally, the liquid white ink does not need to be fed through a print head. Feeding white ink through a print head causes a number of problems since many white inks contain heavy Titanium. These problems are thus avoided through the use of atomizer 30. Moreover, it should be appreciated that first layer 70 may act as a pretreatment for the corrugated stock of box 60 so as to: 1) create a background that has a suitable L* (i.e., creating a white portion on the brown surface 62); and, 2) reduce the porosity of surface 62 prior to application of black ink via high resolution printhead 40.

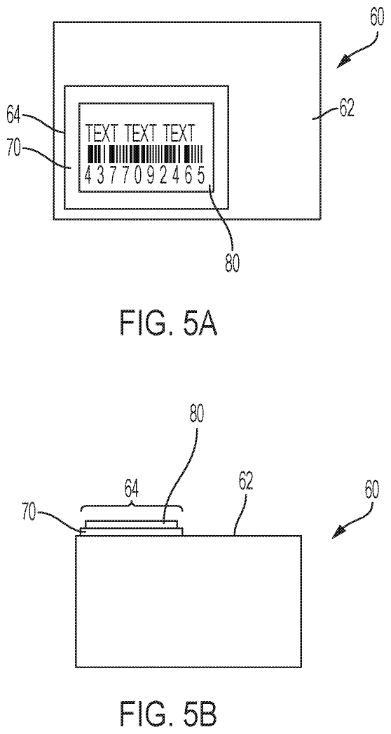

Printhead 40 is operatively arranged over conveyor belt 20 to deliver a marking material (e.g., liquid ink) to box 60 generally in direction D2. As shown in FIGS. 5A-B, printhead 40 delivers second layer 80 to box 60, specifically on layer 70. FIG. 5A is a top elevational view of box 60, with second layer 80 applied thereto. FIG. 5B is a side elevational view of box 60, with second layer 80 applied thereto. Layer 80 forms the label (e.g., barcode, QR code, text) that will be read by an electronic reader, such as a barcode scanner. In some embodiments, printhead 40 is a high resolution printhead that delivers a water-based black ink to layer 70. In some embodiments, printhead 40 applies a solvent-based black ink to layer 70. It should further be appreciated that printhead 40 may deliver a dark colored ink other than black, which sufficiently contrasts with the color of layer 70 such that the machine-readable code of layer 80 can be sufficiently read, for example, brown, blue, green, etc. In some embodiments, printhead 40 is a high resolution printhead run at 1200 dpi (8 pl physical drop volume). In some embodiments, printhead 40 is a low resolution printhead. It should be appreciated that while printhead 40 is arranged to deliver a liquid marking material (i.e., ink), in some embodiments, a dry marking material (i.e., toner) may be used in conjunction with a fuser in order to apply second layer 80 to box 60. It should be appreciated that in some embodiments, printing system 10 may comprise one or more printheads, for example, multiple printheads arranged in series in the process direction.

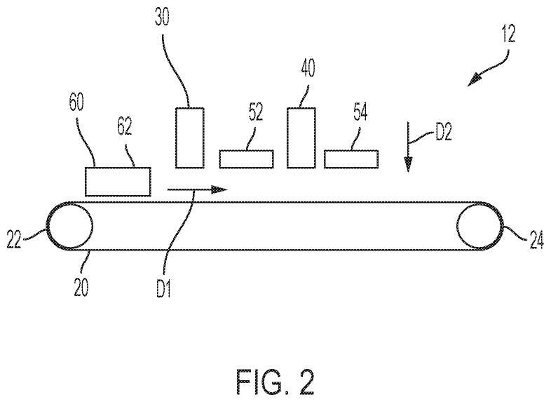

The contrast of the white background layer 70 to the black label layer 80 allows the label or barcode to be read by a barcode scanner/reader as well as regular text perception. In contrast, printing a barcode directly onto the brown corrugated stock of box 60 is not suitable to be read via a barcode scanner. It should be appreciated that printhead 40 may use other ink colors, for example, blue, green, brown, etc., and that the present disclosure should not be limited to the use of only black. It should be appreciated that the use of a high viscosity black ink for layer 80 enables the black ink for layer 80 to be applied immediately to first layer 70 without the need for drying between applications, as shown in FIG. 2. Furthermore, the porosity of the corrugated stock of surface 62 may aid in the drying of white ink layer 70 (i.e., the cardboard sucks in the white ink and helps the ink dry).

Dryer 50 is operatively arranged over conveyor belt 20 to deliver heat to box 60 generally in direction D2. In the embodiment shown, first layer 70 is applied to surface 62 via atomizer 30, then second layer 80 is applied to first layer 70 via printhead 40, and finally heat is applied to dry layers 70 and 80 via dryer 50. It should be appreciated that in some embodiments, printing system 10 does not comprise dryer 50 and layers 70 and 80 dry without the application of heat.

FIG. 2 is a schematic view of printing system 12. It should be appreciated that printing system 12 is substantially similar to printing system 10, but includes two dryers 52 and 54. As shown, first layer 70 is applied to surface 62 via atomizer 30, then heat is applied to dry first layer 70 via dryer 52, then second layer 80 is applied to first layer 70 via printhead 40, and finally heat is applied to dry layer 80 via dryer 54. It should be appreciated that in some embodiments, printing system 10 does not comprise dryer 50 and layers 70 and 80 dry without the application of heat.

It should be appreciated that the white ink of layer 70 and the black ink of layer 80 should have similar surface tensions (typically water based inks are approximately 20-30 dynes/cm). This would minimize intercolor bleed. In some embodiments, the black ink of layer 80 may comprise a higher viscosity (typically water-based inks are approximately 8 cP at room temperature) than the white to minimize flow related artifacts. As previously described, adjusting the surface tensions and viscosities of the white and black inks, could allow use of only a single dryer (as shown in FIG. 1) or no dryer. Additionally, additives can be added to the inks of layers 70 and 80 to enable fast drying. The use of two dryers (as shown in FIG. 2) would not require the adjustment of or detailed attention to the ink chemistry.

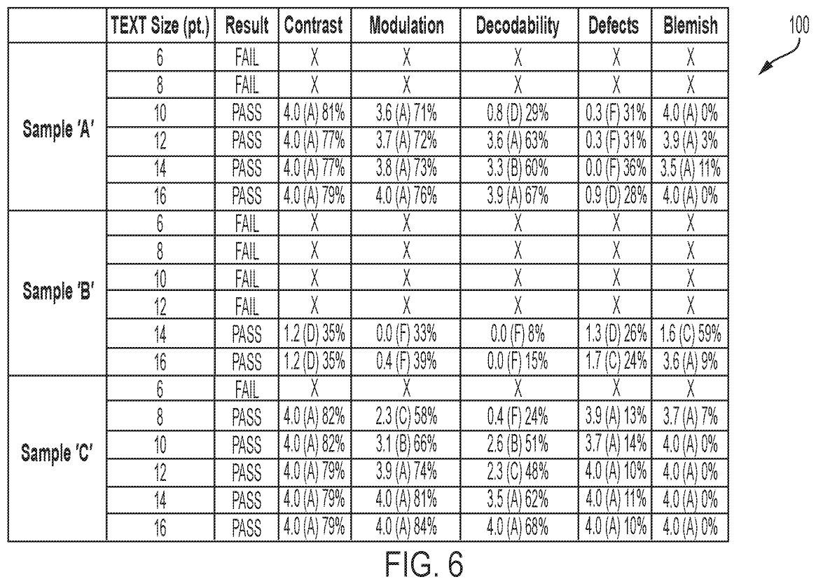

Printing system 10 was tested on corrugated stock by forming three samples, Samples A-C, and comparing the results, as described below and shown in FIG. 6.

Sample A—Sample A was formed using printing system 10 of the present disclosure. First, a low pressure atomizer 30 applied a water-based liquid white ink onto normal brown corrugated stock in a pre-marked area to form first (white) layer 70. Immediately after application of first layer 70, a high resolution printhead 40 applied a water-based liquid black ink onto first layer 70 to form second layer 80. Specifically, printhead 40 printed a series of six barcodes ranging in font size: 6 pt., 8 pt., 10 pt., 12 pt., 14 pt., and 16 pt.

Sample B—Sample B was formed by printing barcodes directly onto normal brown corrugated stock, without any background color or layer. A high resolution print head applied a water-based liquid black ink onto the corrugated stock. Specifically, the printhead printed a series of six barcodes ranging in font size: 6 pt., 8 pt., 10 pt., 12 pt., 14 pt., and 16 pt.

Sample C—Sample C was formed by printing barcodes directly onto white corrugated media. A high resolution print head applied a water-based liquid black ink onto the white corrugated media. Specifically, the printhead printed a series of six barcodes ranging in font size: 6 pt., 8 pt., 10 pt., 12 pt., 14 pt., and 16 pt. It should be appreciated that white corrugated media/stock is expensive and not widely used for packaging applications. However, it is used as a benchmark against which to evaluate printing system 10, for the purposes of reading barcodes on corrugated substrates.

FIG. 6 is a chart 100 showing sample results of Samples A, B, and C. The information in chart 100 corresponds to the readability of the printed barcode. The sample results were obtained using an OMRON LVS® Barcode Verifier (e.g., a LVS-9510 Desktop Barcode Verifier) that produces grading and verifies one dimensional codes (e.g., barcodes) and two dimensional codes (e.g., QR codes) and provides a score based on various standards (e.g., ISO/IEC, ANSI, GS1, and Unique Device Identification (UDI)). For example, the Sample A having text size 10 has a score of 4.0 (A) 81% for contrast, which represents a score of 4.0 (on a scale from 0.0-4.0), a grade of “A” (on a scale from A-F), and a percentage of 81% (on a scale from 0-100%). As can be interpreted from the data of chart 100, the performance of printing system 10, 12 represented by Sample A is vastly superior to the current technology, as represented by Sample B, and is comparable to the ideal benchmark, as represented by Sample C. It should be noted that 10-16 pt. sized barcodes are the most frequently used in packaging applications. As such, printing system 10, 12 provides for late stage marking capability on corrugated stock by using low resolution atomizer 30 to create a white background layer 70 and high resolution printhead 40 to print package specific information (i.e., layer 80) on layer 70, resulting in enhanced contrast for barcodes and text.

Advantages of printing system 10, 12 are as follows.

Increased Reliability: Two major complaints of using labels is the inability to consistently apply the labels squarely on the box and also the labels failing to adequately adhere. It is not uncommon for labels to be arranged on the box severely skewed or fall-off the box somewhere along the filling line or in transport. A sprayed on white background will be square and not peel off.

Lower Material Cost: The cost of adhesive labels is significantly greater than an inexpensive water-based white ink/paint that can be applied (sprayed) in an analog fashion. The primary purpose of the label is to simply create a white background to contrast the printed shipping address and barcode, or in color applications to increase gamut.

Lower Machine Cost: Eliminating the need to ship, store, load, and apply (manually or by machine) a label onto a box reduces cost and enables line speedup due to process limitations of the label application device.

Increased Versatility: Typically, labels are all the same size (height and length). With a spray system, the length of the white background may be easily modified to meet the printing needs of a certain sized box. The printing could occur along the entire length of essentially any custom container.

Increased Control: It is also possible to vary the intensity (mass/area) of the white ink/paint applied. Some images or tags may require more white and some less. It is possible to tailor the amount of white for both image quality and cost savings.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Print system
12 Print system
22 Roller
24 Roller
30 Atomizer
40 Printhead
50 Dryer
52 Dryer
54 Dryer
60 Box or package or corrugated stock
62 Surface
64 Area
70 Layer
80 Layer
100 Chart
D1 Direction
D2 Direction

What is claimed is:

1. A printing system, comprising:
an atomizer operatively arranged to deliver a first ink; and,
a printhead arranged adjacent to the atomizer, the printhead operatively arranged to deliver a second ink, the second ink being different from the first ink;
wherein a print media including a dark color is operatively arranged to pass under, in order, the atomizer and the printhead.

2. The printing system as recited in claim 1, wherein:
the print media comprises corrugated stock; and,
the atomizer applies the first ink to the corrugated stock to form a first layer.

3. The printing system as recited in claim 2, wherein the printhead applies the second ink to the first layer to form a second layer.

4. The printing system as recited in claim 3, wherein the second layer comprises a machine-readable code.

5. The printing system as recited in claim 1, wherein the first ink is a liquid light-colored ink.

6. The printing system as recited in claim 5, wherein the second ink is a liquid dark-colored ink.

7. The printing system as recited in claim 1, further comprising a dryer arranged adjacent to the printhead, wherein the print media is operatively arranged to pass under, in order, the atomizer, the printhead, and the dryer.

8. The printing system as recited in claim 3, further comprising:
a first dryer arranged between the atomizer and the printhead; and,
a second dryer arranged adjacent to the printhead;
wherein the corrugated stock is operatively arranged to pass under, in order, the atomizer, the first dryer, the printhead, and the second dryer.

9. The printing system as recited in claim 8, wherein the first dryer is operatively arranged to dry the first layer and the second dryer is operatively arranged to dry the second layer.

10. The printing system as recited in claim 1, wherein the first layer comprises a brightness L* of greater than or equal to 65.

11. The printing system of claim 10, wherein the first layer comprises a brightness L* of greater than or equal to 92.

12. The printing system as recited in claim 1, wherein:
the first ink comprises a first viscosity;
the second ink comprises a second viscosity; and,
the second viscosity is greater than the first viscosity.

13. A printing system for printing a readable label directly on corrugated stock, comprising:
a low resolution atomizer operatively arranged to apply a white ink to the corrugated stock to form a first layer;
a high resolution printhead operatively arranged adjacent to the low resolution atomizer to deliver a black ink to the first layer to form a code; and,
at least one dryer arranged adjacent to the high resolution printhead to dry at least one of the white ink and the black ink;
wherein the corrugated stock is operatively arranged to pass under the low resolution atomizer, the high resolution printhead, and the at least one dryer.

14. The printing system as recited in claim 13, wherein the at least one dryer comprises:
a first dryer arranged between the low resolution atomizer and the printhead to dry the white ink; and,
a second dryer arranged adjacent the high resolution printhead to dry the black ink.

15. The printing system as recited in claim 13, wherein the first layer is applied only to a portion of the corrugated stock.

16. The printing system as recited in claim 13, wherein the white ink comprises a water-based white liquid ink that is sprayed onto a predetermined area of the corrugated stock.

17. The printing system as recited in claim 13, wherein:
the white ink comprises a first viscosity;
the black ink comprises a second viscosity; and,
the second viscosity is greater than the first viscosity.

18. The printing system as recited in claim 13, wherein:
the white ink comprises a first surface tension;
the black ink comprises a second surface tension; and,
the second surface tension is substantially equal to the first surface tension.

19. A method for printing a readable label directly on corrugated stock having a surface, the method comprising:
applying, via one or more low resolution atomizers, a white ink to a portion of the surface to form a first layer; and,
applying, via one or more high resolution printheads, a black ink to the first layer to form a machine-readable code.

20. The method as recited in claim 19, further comprising:
after the step of applying the white ink, drying, via one or more first dryers, the first layer; and,
after the step of applying the black ink, drying, via one or more second dryers, the machine-readable code.
